(19) United States
(12) Patent Application Publication
(10) Pub. No.: US 2010/0050174 A1
(43) Pub. Date: Feb. 25, 2010

(54) HEAP ORGANIZATION FOR A MULTITASKING VIRTUAL MACHINE

(76) Inventors: Xin Zhou, Beijing (CN); Gansha Wu, Beijing (CN); Jinzhan Peng, Beijing (CN); Zhiwei Ying, Shanghai (CN); Biao Chen, Beijing (CN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/309,392

(22) PCT Filed: Jul. 14, 2006
(86) PCT No.: PCT/CN2006/001688

§ 371 Date: Oct. 28, 2009

(51) Int. Cl. G06F 9/44; G06F 9/46

(52) U.S. Cl. 718/1; 718/107

(57) ABSTRACT

A heap organization for a multitasking virtual machine is described. The heap organization may comprise an execution engine to concurrently execute a plurality of tasks and a plurality of heaps coupled to the execution engine. In some embodiments, the plurality of heaps may comprise a system heap and a task heap separated from the system heap. The system heap may store system data accessible by the plurality of tasks. The task heap may store task data only accessible by one task of the plurality of tasks.

### BACKGROUND

A heap organization is a memory area that may be used to store data for a plurality of tasks that are executed concurrently by a multitasking virtual machine. The data may include program objects and metadata for all of the tasks.

Conventionally, there are two classes of heap organization, shared heap and separated heap. For the shared heap class, the multitasking virtual machine may use a single heap to store data accessible by all of the tasks. For the separated heap class, the multitasking virtual machine may use a number of heaps that are logically separated. Each separated heap may be assigned to store the data that is only accessible by a single task.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing platform including a multi-tasking virtual machine;

FIG. 2 illustrates an embodiment of the multitasking virtual machine;

FIG. 3 illustrates an embodiment of a heap organization in the multitasking virtual machine of FIG. 2;

FIG. 4 illustrates an embodiment of a method of adding a task heap into the heap organization of FIG. 3;

FIG. 5 illustrates an embodiment of a method of reclaiming a task heap from the heap organization of FIG. 3;

FIG. 6 illustrates another embodiment of a heap organization in the multitasking virtual machine of FIG. 2; and

FIG. 7 illustrates still another embodiment of a heap organization in the multitasking virtual machine of FIG. 2.

### DETAILED DESCRIPTION OF THE PREFERRED EMBODIMENTS

The following description describes techniques for heap organization for a multitasking virtual machine. In the following description, numerous specific details such as logic implementations, pseudo-code, methods to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

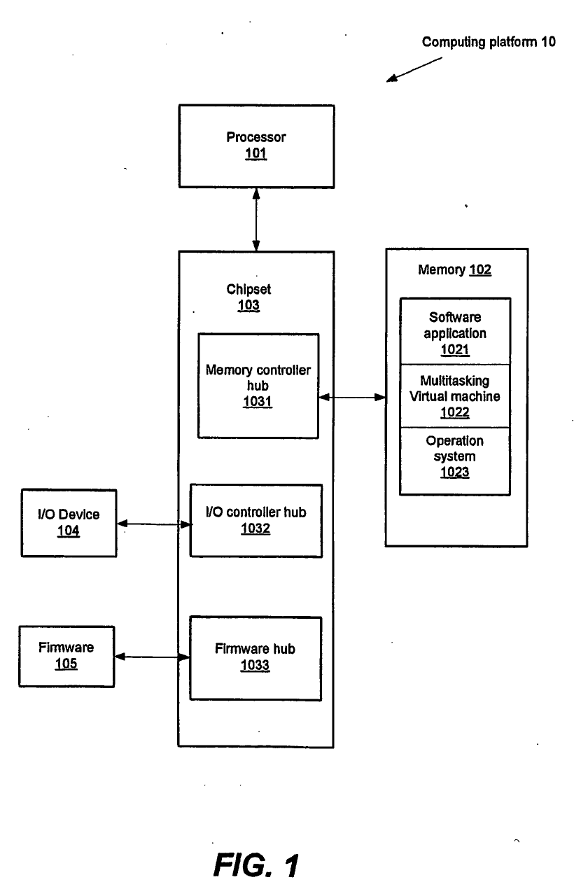

FIG. 1 shows an embodiment of a computing platform 10 comprising a multitasking virtual machine. Examples for the computing platform 10 may include a personal computer, a workstation, a server computer, a personal digital assistant (PDA), a mobile telephone, and a game console.

The computing platform 10 may comprise one or more processors 101, memory 102, chipset 103, I/O devices 104, a firmware 105 and possibly other components. The one or more processors 101 may be communicatively coupled to various components. (e.g., the chipset 103) via one or more buses such as a processor bus. The processors 101 may be implemented as an integrated circuit (IC) with one or more processing cores that may execute codes under a suitable architecture, for example, including Intel® Xeon™, Intel® Pentium™, Intel® Itanium™ architectures, available from Intel Corporation of Santa Clara, Calif.

The memory 102 may store instructions and data in the form of a plurality of software applications 1021, a multitasking virtual machine 1022 and an operation system 1023. Examples for the memory 102 may comprise one or any combination of the following semiconductor devices, such as synchronous dynamic random access memory (SDRAM) devices, RAMBUS dynamic random access memory (RDRAM) devices, double data rate (DDR) memory devices, static random access memory (SRAM), and flash memory devices.

The plurality of software applications 1021 may be input from any suitable devices, such as the I/O devices 106. In other embodiments, the software applications may also be generated by other components within the computing platform 10. Examples for the software applications 1021 may comprise JAVA applications (e.g., JAVA.class files), .NET application (e.g., .NET codes), or applications in possibly other programming languages.

The multitasking virtual machine 1022 may run above the operating system 1023 to concurrently execute the plurality of software applications 1021. Each software application 1021 may include one or more tasks, each of which may represent an instantiation of a single software application 1021. In a JAVA virtual machine, if two ‘tasks’ share the same class path (i.e., same ordered table of the class files), the two ‘tasks’ may belong to one application.

Examples for the multitasking virtual machine 1022 may comprise a multitasking JAVA virtual machine available from Sun Microsystems Inc., Santa Clara, Calif., and a multitasking NET virtual machine available from Microsoft® Corporation, Redmond, Wash. The operation system 1023 may include, but is not limited to, different versions of Linux®, Microsoft® Windows®, and real time operating systems such as VxWorks®, etc.

In an embodiment, the chipset 103 may provide one or more communicative paths among the one or more processors 101, memory 102 and other components, such as the I/O device 104 and firmware 105. The chipset 103 may comprise a memory controller hub 1031, an input/output controller hub 1032 and a firmware hub 1033.

In an embodiment, the memory controller hub 1031 may provide a communication link to the processor bus that may connect with the processors 101 and to a suitable device such as the memory 102. The memory controller hub 102 may couple with the I/O controller hub 1032 to provide an interface to the I/O devices 104 for the computing platform. Examples for the I/O devices 104 may comprise a keyboard, mouse, network interface, a storage device, a camera, a blue-tooth device, and an antenna.

In an embodiment, the memory controller hub 1031 may communicatively couple with a firmware hub 1033 via the input/output controller hub 1032. The firmware hub 1033 may couple with the firmware 105 that may store BIOS routines that the computing platform executes during system startup in order to initialize the processors 101, chipset 103, and other components of the computing platform and/or EFI routines to interface the firmware 105 with an operating system of the computer platform and provide a standard environment for booting the operating system.

Other embodiments may implement other technologies for the structure of the computing platform 10. For example, the multitasking virtual machine 1022 may execute one software application 1021 in one instantiation of the virtual machine. In other words, the multitasking virtual machine 1022 may concurrently execute a plurality of tasks belonging to one application in one instantiation of the virtual machine, and the plurality of tasks are respectively instantiations of the application.

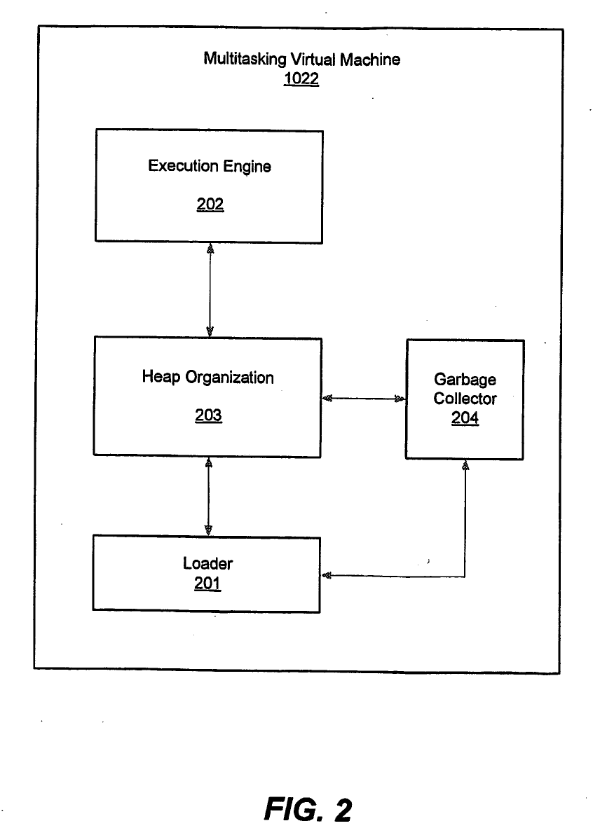

FIG. 2 shows an embodiment of the multitasking virtual machine 1022 of FIG. 1. According to the embodiment, the multitasking virtual machine 1022 may comprise a loader 201, an execution engine 202, a heap organization 203, a heap manager 204 and possibly other components.

The loader 201 may load files (including classes, interfaces, native methods) from various resources. For example, the loader 201 may load the plurality of software applications 1021, libraries, runtime environment variables and possibly other files from the multitasking virtual machine vendor, the programmer and any third parties. The libraries may comprise various functions or routines to provide basic functionalities to user programs, such as bootstrap class libraries and non-bootstrap class libraries. The runtime environment variables may comprise configurations to help the multitasking virtual machine find the application resources. Examples of the loader may comprise class loaders, native method interface, and possibly other loading means.

The execution engine 202 may concurrently execute a plurality of tasks associated with the software applications 1021. More specifically, the execution engine 202 may concurrently translate the software applications and execute the translated codes.

The heap organization 203 may store data for the multitasking virtual machine 1022, such as metadata and program objects. The metadata may comprise information about the files loaded from the loader 201 or other components (e.g., software applications, libraries, runtime environment variables, etc.), translated codes of the files from the execution engine 202 and possibly other data. Examples of the metadata may comprise virtual machine internal representation of JAVA classes, methods, fields, bytecodes, JIT'ed (Just-in-time) codes, and the like. The program objects may comprise objects generated when executing the loaded files. Examples of the program objects may comprise user-defined class loaders and instances of class files.

The heap manager 204 may manage the heap organization 203, for example, with help from the loader 201.

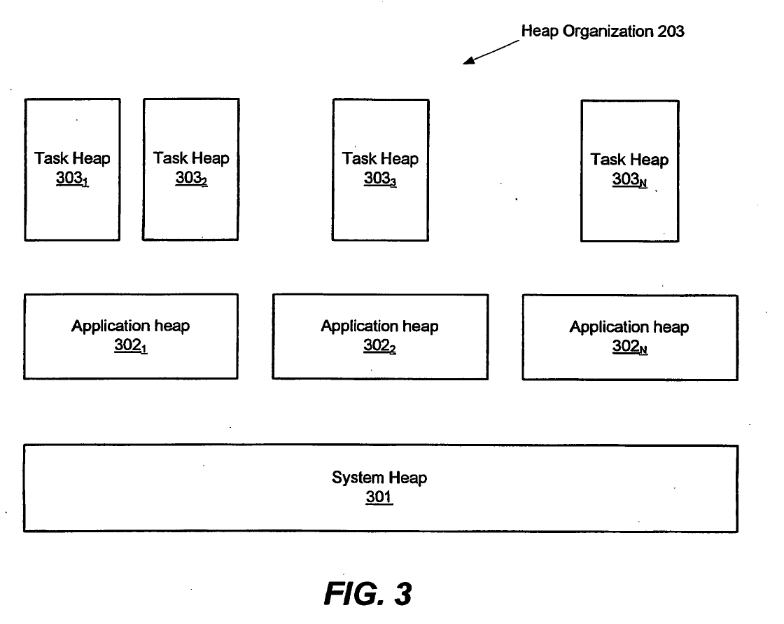

FIG. 3 shows an embodiment of the heap organization 203 of FIG. 2.

The heap organization 203 may comprise a plurality of logically disjointed heaps, wherein each heap may comprise a plurality of logically contiguous memory blocks and no blocks may overlap between two heaps.

In the embodiment of FIG. 3, the heap organization 203 may comprise a system heap 301, a plurality of application heaps 302_{1-N} and a plurality of task heap 303_{1-N}.

The system heap may store system data sharable for all of the tasks executed by the multitasking virtual machine 1022. Lifespan for the data stored in the system heap may be equal to one instantiation of the multitasking virtual machine 1022. Examples of the system data may comprise metadata of globally shared libraries (e.g., bootstrap class libraries, globally shared runtime environment, platform-definition information), program objects having a lifespan equal to the instantiation of the multitasking virtual machine (e.g., the objects generated when executing the bootstrap class program), and possibly other data for the system. In the embodiment of FIG. 3, the system heap 301 is a singleton and may not be subject to reclamations or even compaction.

Each of the application heap 302_{1-N} may be assigned to each ‘live’ application of the plurality of the software applications 1021, in which a ‘live’ application may have at least one task that is executed by the multitasking virtual machine 1022. A task may be an instantiation of its application. Each of the application heap 302_{1-N} may store application data accessible by all of the task(s) belonging to the application and lasting as long as the application. For JAVA virtual machine specification, if two ‘tasks’ belong to one application, the two ‘tasks’ may share the same class path, namely, they may share the same ordered table of class files. In view of this, an application may represent executable binaries (including dynamically loaded binaries) and runtime environment for its tasks.

The application data stored in each of the application heap 302_{1-N} may comprise metadata for the application and program objects that may have the same lifespan as the application. Examples of the metadata for the application may comprise information about application class files, translated codes of the application class files, application libraries and runtime environment variables for translating and executing the application class files, and possibly other data for the application. Examples of the program objects may comprise the objects generated when initializing the application class files. In the embodiment of FIG. 3, the application heap may be reclaimed if the last task of the application is terminated.

Each of the task heaps 303_{1-N} may be assigned to each ‘live’ task executed by the multitasking virtual machine 1022. Each of the task heaps 303_{1-N} may store task data only accessible by the associated task, which 10 means accessing of the task data by other tasks may be prohibited. The task data may have the same lifespan as the associated task. Examples of the task data may comprise program objects generated when executing the task and runtime environment variables for executing the task. In the embodiment of FIG. 3, the task heap may be reclaimed if the associated task is terminated.

As shown in FIG. 3, a task may access the task data stored in its task heap and the system data stored in the system heap. The task may further access the application data stored in the application heap for the application that the task may belong to. Since one application may have more than one tasks being executed by the multitasking virtual machine 1022, one application heap may have more than one task heaps bound therewith. For example, application heap 302₁ may have two task heaps 303₁-303₂ bound therewith. However, the task can not access other application data stored in other application heaps for other applications that the task may not belong to.

Other embodiments may implement other technologies for the structure of the heap organization 203 of FIG. 3. For example, if the multitasking virtual machine 1022 executes one application 1023 during one instance, the heap organization 203 may comprise a system heap to store system data and application data, and a plurality of task heap to store task data.

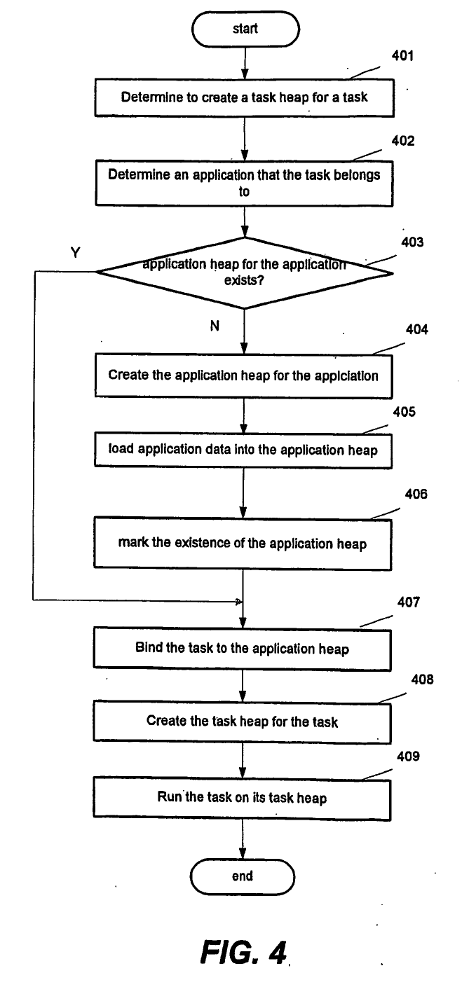

FIG. 4 shows an embodiment of a method of adding a task heap into the heap organization 203 as shown in FIG. 3.

In block 401, the heap manager 204 or other suitable device may determine to create a task heap for a task that may be executed by the multitasking virtual machine 1022. In block 402, the heap manager 204 or other suitable device may determine an application that the task belongs to. As stated above, an application may represent executable binaries (including dynamically loaded binaries) and runtime environment for its task, therefore, the heap manager 204 or other suitable device may determine the application by introspecting executable binaries and runtime environment of the task.

In block 403, the heap manager 204 or other suitable device may determine whether an application heap has been assigned to the application. In an embodiment of block 403, the heap manager 204 or other suitable device may maintain a ‘live’ application table recording all of the ‘live’ applications. Each ‘live’ application may have at least one task that may be executed by the multitasking virtual machine 1022 and therefore may be assigned with an application heap. By this way, the heap manager 204 or other suitable device may determine the application heap has been assigned to the application if the application is listed in the ‘live’ application table and determine the application heap has not been assigned to the application if not listed.

If the application has not been assigned with an application heap, the heap manager 204 or other suitable device may create an application heap for the application in block 404. In block 405, the heap manager 203 or other suitable device may load application data into the application heap. The application data may comprise metadata for the application and program objects having a lifespan equal to the application.

In block 406, the heap manager 203 or other suitable device may mark the existence of the created application heap. In an embodiment of block 408, the heap manager 203 or other suitable device may add the application corresponding to the application heap into the ‘live’ application table.

In block 407, the heap manager 203 or other suitable device may bind the task to the application heap created in block 404, so that the task may access the application data in the application heap. In an embodiment of block 407, the heap manager 203 or other suitable device may add the task into a ‘live’ task table maintained for the application which records each task belonging to the application and executed by the multitasking virtual machine 1022.

Then, in block 408, the heap manager 203 or other suitable device may create a task heap for the task that may be executed by the multitasking virtual machine 1022. The task heap may be created by adding the task heap address, application heap address and system heap address into stacks of the task so that the task may access the data in those heaps. Finally, in block 409, the execution engine 202 of the multitasking virtual machine 1022 may run the task on its task heap.

Referring back to block 403, if an application heap has been assigned to the application corresponding to the task, the heap manager 203 or other suitable device may bind the task to the application heap in block 407, create a task heap for the task in block 408 so that the execution engine 202 may run the task on its task heap in block 409.

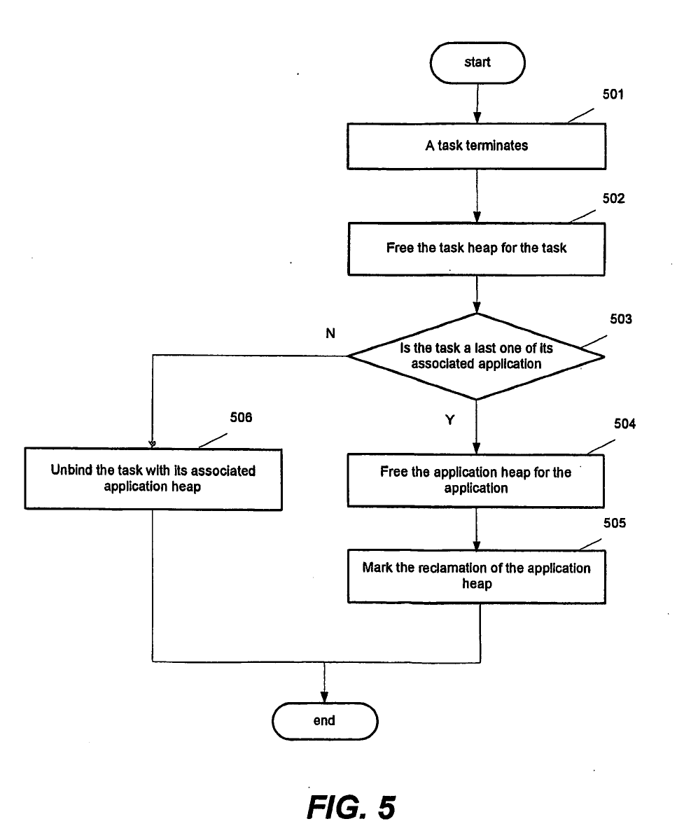

FIG. 5 shows an embodiment of a method of reclaiming a task heap from the heap organization 203.

In block 501, a task may be terminated, for example, when the execution engine 202 completes the execution of the task. In block 502, the heap manager 203 or other suitable device may free a task heap assigned to the task. In an embodiment of block 502, the heap manager 203 may return memory region of the task heap to the operating system as a whole. Then, in block 503, the heap manager 203 or other suitable device may determine whether the task is the last task of the application it belongs to. The heap manager 203 or other suitable device may implement block 203 in various ways, for example, by checking the above-described ‘live’ task table maintained for the application to determine whether the task is the last one in the ‘live’ task table.

If the task is not the last task of the application, the heap manager 203 or other suitable device may unbind the task from an application heap assigned to the application in block 506. The unbinding may be implemented by deleting the task from the ‘live’ task table maintained for the application. However, if the task is the last task of the application, the heap manager 203 or other suitable device may reclaim the application heap for the application in block 504. The heap manager 203 or other suitable device may implement block 504 in various ways, for example, by returning memory region of the application heap to the operation system as a whole. Then, in block 505, the heap manager 203 or other suitable device may mark the reclamation of the application heap, for example, by deleting the corresponding application from the above-described ‘live’ application table.

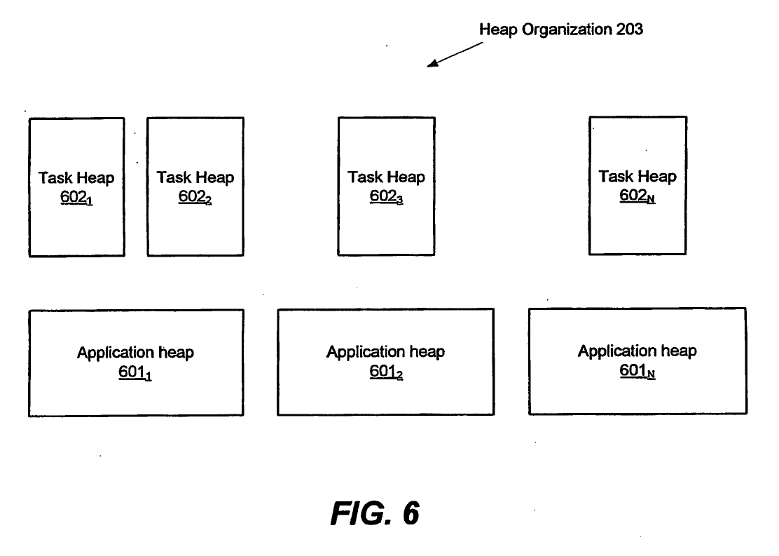

FIG. 6 shows another embodiment of the heap organization 203 of FIG. 2.

The heap organization 203 may comprise a plurality of application heaps 601_{1-N} and a plurality of task heaps 602_{1-N}. Each of the application heaps 601_{1-N} may be assigned to one of the applications 1021. Each application heap may comprise system data and application data only accessible by the task(s) belonging to the application and lasting as long as the application. The system data may comprise metadata and program objects of globally shared libraries and globally shared runtime environment, and the application data may comprise metadata and program objects of the application classes, application libraries and application runtime environment.

Each of the task heaps 602_{1-N} may be assigned to each task executed by the multitasking virtual machine. Each task heap may store task data only accessible by the associated task and lasting as long as the associated task. The task data may comprise program objects and runtime environment for the task. Each of the task heaps 602_{1-N} may be bound to one of the application heaps 601_{1-N}, So that the task can access the data in the task heap as well as the application task.

Other embodiments may implement other technologies for the structure of the heap organization of FIG. 6. For example, the system data may be copied into each task heap 602_{1-N}. but not into each application heap 601_{1-N}.

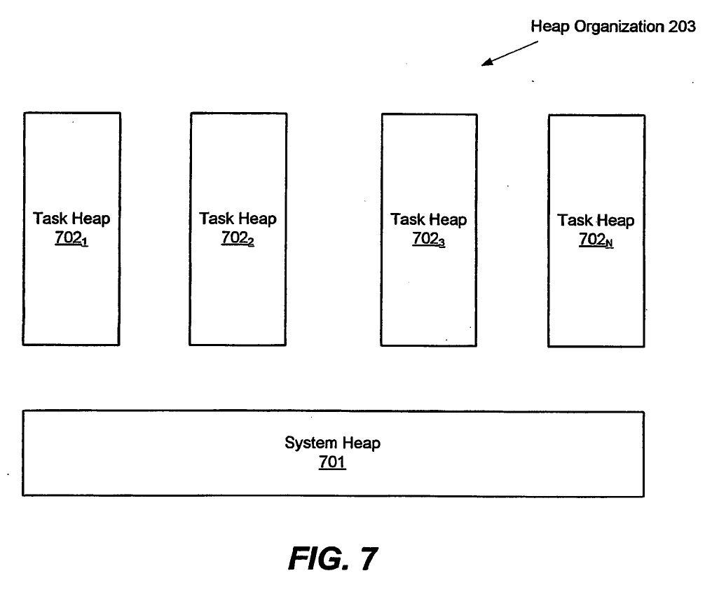

FIG. 7 shows still another embodiment of the heap organization 203 of FIG. 2.

As shown, the heap organization 203 may comprise a system heap 701 and a plurality of task heaps 702_{1-N}. The system heap 701 may store system data accessibly by all of the tasks executed by the multitasking virtual machine 1022 and lasting as long as an instantiation of the multitasking virtual machine 1022. The system data may comprise metadata for globally shared libraries and globally shared runtime environment variables, and program objects that may last as long as the instantiation of the multitasking virtual machine, and possibly other system data.

Each of the task heap 702_{1-N} may be assigned to each task executed by the multitasking virtual machine 1022. Each task heap may store application data and task data only accessible by the associated task. The application data may comprise metadata and program objects for the application classes, application libraries and runtime environment, and possibly other data for the application. The task data may comprise program objects and runtime environment variables for the task.

Although the present invention has been described in conjunction with certain embodiments, it shall be understood that modifications and variations may be resorted to without departing from the spirit and scope of the invention as those skilled in the art readily understand. Such modifications and variations are considered to be within the scope of the invention and the appended claims.

What is claimed is:

1. A multitasking virtual machine, comprising:
an execution engine to concurrently execute a plurality of tasks;
a plurality of heaps coupled to the execution engine, wherein the plurality of heaps comprises:
a system heap to store system data accessible by the plurality of tasks; and
a task heap assigned to one task of the plurality of tasks to store task data only accessible by the assigned task.

2. The multitasking virtual machine of claim 1, wherein the system data comprises system metadata of a globally shared library and a globally shared runtime environment variable.

3. The multitasking virtual machine of claim 1, wherein the system data comprises a program object having a lifespan equal to the lifespan of the multitasking virtual machine.

4. The multitasking virtual machine of claim 1, wherein the task data comprises a program object having a lifespan equal to the lifespan of the assigned task.

5. The multitasking virtual machine of claim 1, wherein the plurality of heaps further comprises:
an application heap assigned to an application to store application data of the application, wherein the application data is only accessible by at least one task of the plurality of tasks that is associated with the application.

6. The multitasking virtual machine of claim 5, wherein the application data comprises application metadata of an application class file, an application library and an application runtime environment variable.

7. The multitasking virtual machine of claim 5, wherein the application data comprises a program object having a lifespan equal to the lifespan of the application.

8. The multitasking virtual machine of claim 1, further comprising a heap manager to reclaim the task heap if the assigned task is terminated.

9. The multitasking virtual machine of claim 5, further comprising a heap manager to reclaim the application heap if the at least one task associated with the application is terminated.

10. A multitasking virtual machine, comprising:
an execution engine to concurrently execute a plurality of tasks;
a plurality of heaps coupled to the execution engine, wherein the plurality of heaps comprises:
a task heap assigned to one task of the plurality of tasks to store task data only accessible by the assigned task; and
an application heap assigned to an application to store application data only accessible by at least one task of the plurality of tasks, wherein the at least one task is associated with the application and comprises the assigned task.

11. The multitasking virtual machine of claim 10, wherein the application data comprises system metadata of a globally shared library and a globally shared runtime environment variable, and application metadata of an application class file, an application library and an application runtime environment variable.

12. The multitasking virtual machine of claim 10, wherein the application data comprises application metadata of an application class file, an application library and an application runtime environment variable, and wherein the task data comprises system metadata of a globally shared library and a globally shared runtime environment variable.

13. The multitasking virtual machine of claim 10, wherein the application data comprises a program object having a lifespan equal to the lifespan of the application.

14. The multitasking virtual machine of claim 10, wherein the task data comprises a program object having a lifespan equal to the lifespan of the task.

15. The multitasking virtual machine of claim 10, further comprising a heap manager to reclaim the task heap if the task is terminated.

16. The multitasking virtual machine of claim 10, further comprising a heap manager to reclaim the application heap if the at least one task associated with the application is terminated.

17. A method of a multitasking virtual machine, comprising:
providing a task heap assigned to one task of a plurality of tasks, wherein the task heap stores task data only accessible by the assigned task; and
determining whether an application heap assigned to an application exists, wherein the application heap stores application data only accessible by at least one task of the plurality of tasks, wherein the at least one task is associated with the application and comprises the assigned task.

18. The method of claim 17, wherein the determining further comprises:
determining the application associated with the assigned task; and
determining whether the application exists in a live application table which records each application having at least one task of the plurality of tasks executed by the multitasking virtual machine.

19. The method of claim 17, further comprising providing the application heap if the application heap does not exist in the multitasking virtual machine.

20. The method of claim 17, further comprising marking existence of the application heap.

21. The method of claim 20, wherein the marking further comprises adding the application into a live application table which records each application having at least one task of the plurality of tasks executed by the multitasking virtual machine.

22. The method of claim 17, further comprising binding the assigned task to the application heap so that the assigned task can access the application data stored in the application heap.

23. The method of claim 22, wherein the binding further comprises adding the assigned task into a live task table for the application, wherein the live task table records each task associated with the application and executed by the multitasking virtual machine.

24. A machine-readable medium comprising a plurality of instructions which when executed result in a multitasking virtual machine:
reclaiming a task heap assigned to one task of a plurality of tasks from the multitasking virtual machine, wherein the task heap stores task data only accessible by the assigned task; and
determining whether to reclaim an application heap assigned to an application from the multitasking virtual machine, wherein the application heap stores application data only accessible by at least one task of the plurality of tasks, wherein the at least one task is associated with the application and comprises the assigned task.

25. The machine-readable medium of claim 24, wherein the plurality of instructions that result in the multitasking virtual machine determining whether to reclaim the application heap, further result in the multitasking virtual machine:
determining whether the assigned task is the last task listed in a live task list that records each task associated with the application and executed by the multitasking virtual machine; and
determining to reclaim the application heap if the assigned task is the last task in the live task list.

26. The method of claim 24, wherein the plurality of instructions further result in the multitasking virtual machine:
unbinding the assigned task from the application heap in response to determining not to reclaim the application heap.

27. The method of claim 26, wherein the plurality of instructions that result in the multitasking virtual machine unbinding the task, further result in the multitasking virtual machine:
deleting the assigned task from a live task list that records each task associated with the application and executed by the multitasking virtual machine.

28. The method of claim 24, wherein the plurality of instructions further result in the multitasking virtual machine:
reclaiming the application heap from the multitasking virtual machine; and
marking the reclamation of the application heap.

29. The method of claim 28, wherein the plurality of instructions that result in the multitasking virtual machine marking the reclamation, further result in the multitasking virtual machine:
deleting the application from a live application table which records each application having at least one task of the plurality of tasks executed by the multitasking virtual machine.
